(19) United States
(12) Patent Application Publication
(10) Pub. No.: US 2004/0119261 A1
(43) Pub. Date: Jun. 24, 2004

(54) Modular drive system

(76) Inventor: William E. Troutman, Portland, TN (US)

Correspondence Address: DINSMORE & SHOHL, LLP, 1900 CHEMED CENTER, 255 EAST FIFTH STREET, CINCINNATI, OH, 45202, US

(21) Appl. No.: 10/328,902

(22) Filed: Dec. 24, 2002

(51) Int. Cl. B62M 1/02

(52) U.S. Cl. 280/259

(57) ABSTRACT

A modular drive system is for a bicycle that has a wheel support tube, a pedal crank, and a rear wheel. The pedal crank is coupled to a pedal gear for rotation therewith and the rear wheel is coupled to a wheel gear for rotation therewith. The drive system comprises a shaft having first and second ends spaced at predetermined positions along a single longitudinal access. The shaft is substantially parallel to and spaced from the wheel support tube and has a first gear attached adjacent to the first end and a second gear attached adjacent to the second end. The shaft also has at least one retainer section that has a diameter different than other adjacent sections of the shaft. A first bracket is adjacent to the pedal gear and carries a first shaft support having an opening sized to rotatably receive a first portion of the shaft. A second bracket is placed adjacent to the wheel gear and carries a second shaft support having an opening sized to rotatably receive a second portion of the shaft. The retainer section is associated with one of the first and second portions. Also, the first and second shaft supports secure the shaft such that the first gear drivingly contacts the pedal gear and the second gear drivingly contacts the wheel gear.

### TECHNICAL FIELD

The present invention relates to bicycles. More particularly, a modular drive system includes a shaft having first and second gears, the first gear in driving contact with the pedal gear of a bicycle and the second gear in driving contact with the wheel gear of a bicycle.

### BACKGROUND OF THE INVENTION

A typical bicycle employs a chain-drive system involving a chain and a plurality of sprockets to facilitate transmission of power from the bicycle's pedals to one or more of its wheels. During operation of such a bicycle, it is not uncommon for the chain to lose contact with (or to “fall off”) the sprocket(s), thereby causing the bicycle to cease motion and require immediate realignment or repair by an operator. Replacement or repair of such a bicycle chain can be quite time-consuming and frustrating for an operator.

Furthermore, in normal use, a chain is prone to transmitting grease onto the clothing of an operator. Also, chain-drive systems often involve numerous parts, many of which involve substantial complexity. Accordingly, there is a need for a simple, inexpensive, clean, light-weight and accessible drive system for a bicycle that does not involve a chain. Furthermore, there is a need for a drive system for a bicycle that is easily upgradeable and/or replaceable.

### SUMMARY OF THE INVENTION

It is an aspect of the present invention to provide a simple, inexpensive, clean, light-weight and accessible drive system for a bicycle that does not involve a chain. It is another aspect of the present invention to provide a drive system for a bicycle that is easily upgradeable and/or replaceable.

In one embodiment of the present invention, a modular drive system for a bicycle is provided. The bicycle includes a wheel support tube, a pedal crank and a rear wheel. The pedal crank is coupled to a pedal gear for rotation therewith, and the rear wheel is coupled to a wheel gear for rotation therewith. The drive system includes a shaft having first and second ends spaced at predetermined positions along a single longitudinal axis. The shaft is substantially parallel to and is spaced from the wheel support tube and has a first gear attached adjacent to the first end and a second gear attached adjacent to the second end. The shaft also has at least one retainer section, wherein the retainer section comprises a diameter different than other adjacent sections of the shaft. A first bracket is adjacent to the pedal gear and carries a first shaft support having an opening sized to rotatably receive a first portion of the shaft. A second bracket is adjacent to the wheel gear and carries a second shaft support having an opening sized to rotatably receive a second portion of the shaft. The retainer section is associated with one of the first and second portions, and the first and second shaft supports secure the shaft such that the first gear drivingly contacts the pedal gear and the second gear drivingly contacts the wheel gear.

In another embodiment of the present invention, a modular drive system for a bicycle is provided. The bicycle includes a wheel support tube, a pedal crank and a rear wheel. The pedal crank is coupled to a pedal gear for rotation therewith, and the rear wheel is coupled to a wheel gear for rotation therewith. The drive system includes a one-piece continuous shaft having first and second ends spaced at predetermined positions along a single longitudinal axis. The shaft is substantially parallel to and spaced from the wheel support tube and has a first gear attached adjacent to the first end and a second gear attached adjacent to the second end. At least one of the first gear and second gear is removably attached to the shaft. The shaft also has at least one retainer section, wherein the retainer section comprises a diameter different than other adjacent sections of the shaft. A first bracket is adjacent to the pedal gear and carries a first shaft support having an opening sized to rotatably receive a first portion of the shaft. A second bracket is adjacent to the wheel gear and carries a second shaft support having an opening sized to rotatably receive a second portion of the shaft. The retainer section is associated with one of said first and second portions, and the first and second shaft supports secure the shaft such that the first gear drivingly contacts the pedal gear and the second gear drivingly contacts the wheel gear.

One advantage of the present invention is its provision of a simple, inexpensive, clean, light-weight and accessible drive system for a bicycle that does not involve a chain. Another advantage is its provision of a bicycle drive system that is easily upgradeable and/or replaceable. Additional aspects, advantages, and novel features of the invention will be set forth in part in the description that follows, and in part will become apparent to those skilled in the art upon examination of the following or may be learned with the practice of the invention. The aspects and advantages of the invention may be realized and attained by means of the instrumentalities and combinations particularly pointed out in the appended claims.

### BRIEF DESCRIPTION OF THE DRAWINGS

While the specification concludes with claims particularly pointing and distinctly claiming the present invention, it is believed that the same will be better understood from the following description taken in conjunction with the accompanying drawings in which:

FIG. 1 is a partial side view of a bicycle having a drive system in accordance with one embodiment of the present invention;

FIG. 2 is an enlarged partial top plan view depicting the drive system of the bicycle of FIG. 1;

FIG. 3 is a partial cross-section of the drive system of the bicycle taken along section line 3-3 in FIG. 2 illustrating details of a bracket and shaft support;

FIG. 4 is a partial cross-section of the drive system of the bicycle taken along section line 4-4 in FIG. 2 illustrating details of a bracket and shaft support;

FIG. 5 is a partial front exploded perspective view of the shaft and the second gear of the drive system of FIG. 3; and

FIG. 6 is a partial top cross-section of the drive system taken along section line 6-6 in FIG. 1 illustrating details of the shaft, brackets and shaft supports.

### DETAILED DESCRIPTION OF EXEMPLARY EMBODIMENTS

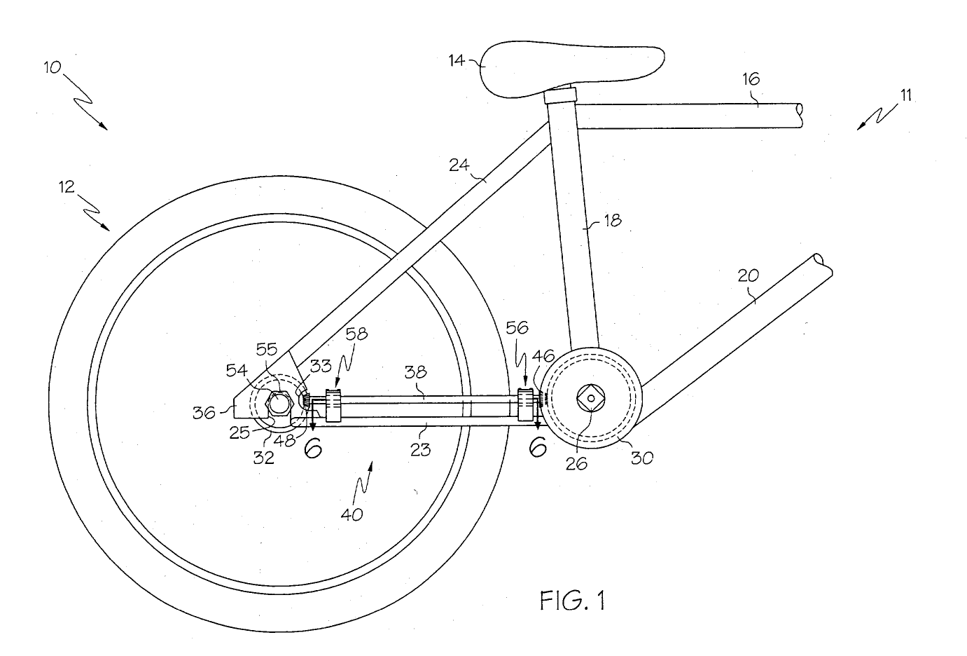

The present invention and its operation is hereinafter described in detail in connection with the views and examples of FIGS. 1-6, wherein like numbers indicate the same or corresponding elements throughout the views. Referring to FIG. 1, an embodiment of a drive system 40 according to the present invention is shown in conjunction with a bicycle 10. Although bicycle 10 generally resembles a racing-type dirt bike, it is to be understood that a drive system (e.g., 40) of the present invention can be associated with virtually any style of bicycle including, for example, tricycles, tandem bicycles, and exercise bicycles.

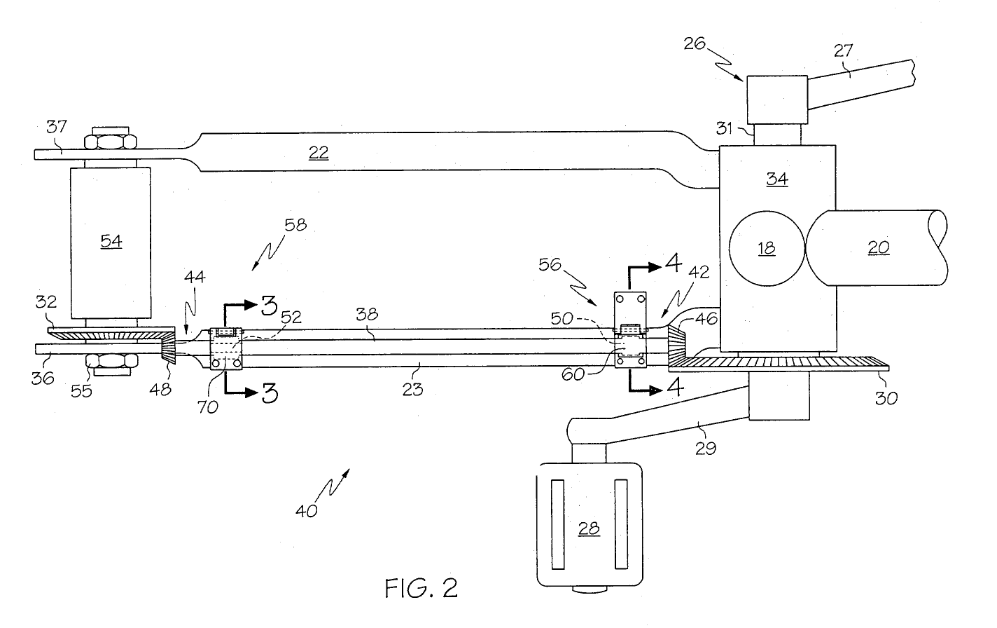

The exemplary bicycle 10 of FIG. 1 includes a frame 11 having a plurality of frame members. As seen best in FIGS. 1-2, exemplary frame members might include a right flange 36, left flange 37, right seat stay tube 24, left seat stay tube (not shown), seat post tube 18, down tube 20, top tube 16, and bottom bracket housing 34. Frame 11 might also include a right wheel support tube 23 and a left wheel support tube 22, wherein wheel support tubes 22 and 23 might be similar to the chain tubes of certain conventional bicycles. It is further contemplated that frame 11 can include any number of head tubes and front fork/handlebar configurations as are available in the industry, although none of these configurations are depicted in the attached figures. In one embodiment, right flange 36 can include a cutout or dropout 25 for receiving a portion of a hub 54 of a rear wheel 12. Left flange 37 might include a similar dropout arrangement, also for receiving a portion of hub 54. After hub 54 is inserted into the dropouts (e.g., 25) of flanges 36 and 37, hub 54 can be secured therein with a nut 55 or another mechanical interface device (e.g., a bracket and/or clip). By securing hub 54 to flanges 36 and 37, rear wheel 12 can be prevented from disengaging from frame 11 during operation of bicycle 10. In one embodiment, as shown in FIG. 1, dropout 25 can be directed toward the ground (as opposed to rearwardly, for example). Because of this downward orientation, dropout 25 can more uniformly maintain rear wheel 12 at an optimal distance from the pedal gear 30, thus ensuring continued optimal alignment between hub 54 and other components of drive system 40, as will be explained further below.

An exemplary configuration of frame 11 is depicted in FIGS. 1 and 2. Right flange 36 of frame 11 attaches to right seat stay tube 24 and to right wheel support tube 23. Left flange 37 attaches to left seat stay tube (not shown) and to left wheel support tube 22. Right wheel support tube 23 and left wheel support tube 22 also fasten to bottom bracket housing 34 which further connects to seat post tube 18 and down tube 20. Seat post tube 18 additionally fastens to right seat stay tube 24, left seat stay tube (not shown) and to top tube 16. In alternate embodiments, entirely different selections and combinations of frame components might constitute a frame 11 of a bicycle 10 having a drive system 40 in accordance with the teachings of the present invention. Hence, drive system 40 can be implemented upon a bicycle having virtually any frame configuration.

Regardless of the specific frame structure selected for such a bicycle 10, each of the connections, attachments, or fastenings among various frame members (e.g., between flange 36 and right wheel support tube 23) can be effectively achieved through use of welding, brazing, fasteners, adhesives, or any of a variety of known fastening techniques. Alternatively, two or more components of frame 11 might be formed as a single unitary structure, such as through a common casting or molding process, for example. It should be understood, however, that the type of fastening or connection among frame members will likely depend upon the type(s) of materials forming the frame members. Such materials might include any of a variety of materials, including for example, aluminum, steel, alloys, stainless steel, titanium, carbon fiber, composites, fiberglass, plastic, any other suitable material, and/or a combination thereof. Although all members of frame 11 might be formed from the same material(s), alternate embodiments of frame 11 might involve members formed from different materials.

A seat 14 can be associated with seat post tube 18 and can be configured to support a seated operator, such as when the seated operator is operating bicycle 10 by rotating its pedals (e.g., 28). As seen best in FIG. 2, pedals (e.g., 28) can connect to a left arm 27 and a right arm 29 of a pedal crank 26. Left arm 27 and right arm 29 can be connected with a crank spindle 31 which passes through bottom bracket housing 34 of frame 11. One or more bearings (e.g., a bottom bracket bearing) and/or other mechanical components might also be associated with crank spindle 31 and can be disposed within bottom bracket housing 34. A pedal gear 30 can be associated with pedal crank 26 such that pedal gear 30 turns in synchronization as pedal crank 26 is powered by an operator. Also, a wheel gear 32 can be associated with hub 54 of rear wheel 12, such that hub 54 and rear wheel 12 can rotate synchronously with wheel gear 32 when wheel gear 32 is caused to rotate.

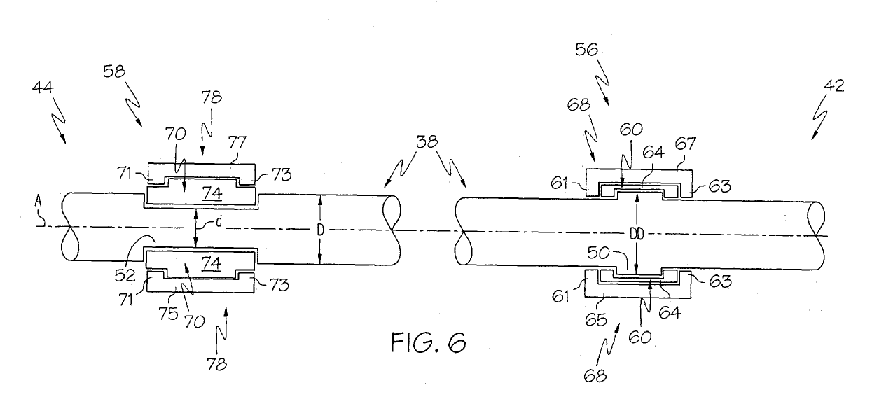

In accordance with the present invention as depicted by the example of FIGS. 1-2 and 6, a shaft 38 might be provided having a first end 42 and a second end 44. Shaft 38 might comprise a plurality of shorter shafts coupled together, but in this exemplary embodiment, comprises a single, one-piece and unitary shaft. In any event, shaft 38 has a single longitudinal axis (e.g., “A” in FIG. 6). A first gear 46 can be associated with the first end 42 of shaft 38, while a second gear 48 can be associated with the second end 44 of shaft 38. In one embodiment, first gear 46 and/or second gear 48 might be integral with shaft 38, such as through common forming or casting for example. In another embodiment, however, first gear 46 and/or second gear 48 might be removably connected to shaft 38 (e.g., see FIG. 5).

More particularly, as depicted in the illustration of FIG. 5, second gear 48 might be removably connected to shaft 38 by a fastener, such as bolt 100. Bolt 100 (e.g., with left-hand threading) can be inserted through an aperture 99 in second gear 48 and into a threaded aperture 89 in second end 44 of shaft 38. In this manner, second gear 48 can be selectively and removably secured to second end 44 of shaft 38. In order to prevent second gear 48 from rotating with respect to shaft 38, one or more tongues or keys 91, 95 can be provided on second end 44 of shaft 38 to interface one or more grooves or keyways 93, 97 provided in second gear 48, respectively. By mere removal of bolt 100, second gear 48 can be removed from shaft 38 and can be easily replaced and/or modified. It is to be understood that first gear 46 might also be removably connected to first end 42 of shaft 38, and that gears 46, 48 might be removably connected to shaft 38 in ways other than those specifically described herein, but otherwise known in the art or developed by those skilled in the art.

Shaft 38 and gears 46, 48 can be formed from any material having sufficient strength to continually facilitate the transmission of power from the pedals (e.g., 28) to rear wheel 12. For example, steel, alloys, plastic, carbon-fiber, composites, aluminum, titanium, or another suitably strong and rigid material, or a combination thereof, might be used to form the shaft 38 and/or the gears 46, 48. More particularly, such materials might include COMTUF® (manufactured by ComAlloy International Corporation, Nashville, Tenn.) and/or POLYPUR® (manufactured by A. Schulman, Inc., Akron, Ohio). In one embodiment, shaft 38 might be manufactured from the same material(s) as one or more gears 46, 48. In another embodiment, however, gears 46 and 48 might be manufactured from different materials than shaft 38. It is also to be understood that although first and second gears 46, 48 are depicted in FIGS. 1, 2 and 5 as being bevel-type gears, any of a variety of gears may alternatively be implemented, including for example worm-type gears, spur-type gears, helical-type gears, and straight-type gears. Also, in some embodiments, first gear 46 might be of a different type than second gear 48.

Shaft 38 can be supported parallel to and spaced from a wheel support tube (e.g., 22 or 23) in order that shaft 38 can be easily maintained and/or replaced by an operator when necessary or desired. In order to facilitate such an arrangement, one or more brackets (e.g., 56, 58) might be provided to maintain shaft 38 in a predetermined position with regard to a wheel support tube (e.g., 22 or 23), thereby ensuring that first gear 46 properly interfaces pedal gear 30 and that second gear 48 properly interfaces wheel gear 32. For example, as shown in FIGS. 1-4 and 6, a first bracket 56 can be associated, with right wheel support tube 23 near the interface between first gear 46 and pedal gear 30 for example. Also, a second bracket 58 can be associated with right wheel support tube 23 and disposed near the interface between second gear 48 and wheel gear 32, for example. Although both first and second brackets 56, 58 are depicted in FIGS. 1-4 as being fastened or otherwise associated with right wheel support tube 23, in other embodiments of the present invention, the number and placement of such brackets can vary substantially, particularly when the specific design of frame 11 is different from that depicted in FIG. 1. For example, in other embodiments, bracket 58 might be associated with right flange 36 and/or right seat stay tube 24. Also, bracket 56 might alternatively be associated with bottom bracket housing 34 and/or seat post tube 18, for example. In still another example, first and second brackets might be integral with a single bracket assembly, wherein this single bracket assembly supports shaft 38. Such a single bracket assembly might be located near the center of shaft, and might be elongated to span a more significant longitudinal portion of shaft 38 than either of the brackets shown in FIGS. 1-2, for example. In still another embodiment, more than two brackets might be provided to support a single shaft 38.

As mentioned, FIGS. 4 and 6 depict enlarged cross-sectional views of first bracket 56. In this example, first bracket 56 includes a body 68 having a front wall 65 and a rear wall 67. As shown in FIG. 6, body 68 can also include side walls 61 and 63. Referring to FIGS. 4 and 6, a first shaft support 60 can be disposed within a cavity defined by front wall 65, rear wall 67, and side walls 61 and 63.

First shaft support 60 can be generally configured to surround shaft 38 and to facilitate the interaction of shaft 38 with first bracket 56. First shaft support 60 might comprise, for example, a bushing, bearing, sleeve, or another suitable mechanical interface device. In one embodiment of the present invention, first shaft support 60 can comprise a split bushing, for example, including a first sandwich member 62 and a second sandwich member 64. In such an embodiment, each sandwich member 62, 64 might include a half-moon shaped indentation (e.g., 51 and 53, respectively) that is configured to correspond with and receive at least a portion of the outer surface of shaft 38, for example. In addition, each sandwich member 62, 64 can have an external configuration suitable to be snugly fitted at least partially within the cavity of body 68. In use, second sandwich member 64 can first be placed within the cavity of body 68. Shaft 38 can then be placed within the cavity such that shaft 38 partially engages indentation 53 within second sandwich member 64. First sandwich member 62 can then be placed within the cavity such that indentation 51 engages shaft 38. When assembled, placement of first sandwich member 62 upon second sandwich member 64 causes indentations 51 and 53 to become adjacent to one another and to resultantly define an opening suitable to rotatably receive and support shaft 38.

A cover 80 can then be associated with bracket 56 in order to prevent first shaft support 60 (and shaft 38, if present) from escaping the cavity of body 68 (e.g., in a direction normal to axis “A”). In one embodiment, cover 80 might fasten to rear wall 67 of body 68 with a hinge 84, for example. In such an example, when cover 80 is pivoted along the hinge 84 with respect to body 68 such that cover 80 substantially closes against body 68, a fastener 88 (e.g., a bolt) can be inserted through an aperture 92 in cover 80 and into an aligned threaded aperture 96 in front wall 65 of body 68. Fastener 88 can maintain cover 80 firmly in place against body 68, thereby properly securing first shaft support 60 (and shaft 38, if present) within the cavity of bracket 56. It is to be understood that any combination of hinges, screws, or other fasteners can be employed to secure cover 80 in place against body 68 of first bracket 56. Also, in the event that a hinge 84 is employed to at least partially secure cover 80 against body 68, gaps 85 might be provided to enable the unimpeded swivel of cover 80 with respect to body 68 as cover 80 is opened and/or closed along hinge 84. In other embodiments, a cover might not be provided, such as when the first shaft support is directly secured within the cavity of bracket 56 by fasteners, adhesives, and/or by any other form of connection.

In one embodiment of the present invention, shaft 38 can include at least one retainer section. A retainer section could comprise any mechanical configuration (e.g., a narrowed or enlarged section of shaft 38) that operates to prevent substantial longitudinal movement of shaft 38 in use. As most clearly depicted in FIGS. 4 and 6, shaft 38 can include a retainer section comprising an enlarged section 50. Enlarged section 50 can have an increased diameter “DD” with respect to other adjacent portions of shaft 38 (e.g., “D”) and might be formed integrally with shaft 38 during molding or other formation of shaft 38. However, in an alternate embodiment, enlarged section 50 might be added to shaft 38 after shaft 38 has been formed, and might for example comprise a sleeve or an E-clip mechanically fastened to a portion of shaft 38 so as to increase the shaft's diameter along a certain longitudinal section of shaft 38 (e.g., a longitudinal length shorter than the portion of shaft 38 passing through first shaft support 60 and/or first bracket 56). As still another alternative, shaft 38 can be machined to provide a plurality of spaced grooves or reduced diameter portions, thereby resulting in one or more enlarged sections 50 of shaft 38 being disposed between such grooves.

First shaft support 60 can be configured to have an opening large enough to surround enlarged section 50. However, first shaft support 60 might also include one or more adjacent openings that are each large enough to surround a longitudinal section of shaft 38 adjacent to enlarged section 50, but that are sufficiently small to exclude enlarged section 50. In this manner, first shaft support 60 can be maintained at a substantially fixed longitudinal position with respect to shaft 38. In use, shaft 38 can be resultantly maintained within first shaft support 60 such that shaft 38 is freely rotatable yet substantially prevented from significant movement longitudinally and laterally with respect to bracket 56. When drive system 40 is so configured, the longitudinal position of shaft 38 can be continually maintained, thereby ensuring that gears 46 and 48 remain consistently and operatively meshed with pedal gear 30 and wheel gear 32, respectively.

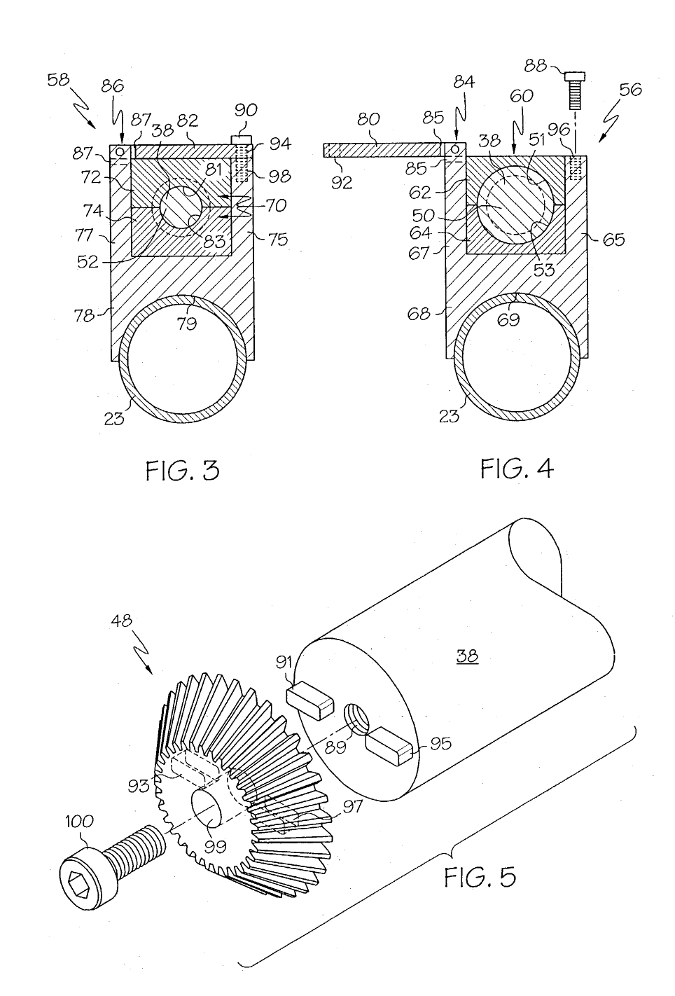

Turning now to FIG. 3, an enlarged cross-sectional view of second bracket 58 is depicted. In one embodiment, second bracket 58 might involve a slightly or entirely different configuration than first bracket 56. However, in the embodiment depicted by FIGS. 1-4 and 6, second bracket 58 is depicted as having a configuration similar to that of first bracket 56. More particularly, second bracket 58 is illustrated in this example as including a body 78 having a front wall 75 and a rear wall 77. As shown most clearly by FIG. 6, second bracket 58 might also include side walls 71 and 73. Together, front wall 75, rear wall 77 and side walls 71, 73 can substantially define a cavity into which a second shaft support 70 can be inserted for rotatable support of shaft 38.

Second shaft support 70 might include a first sandwich member 72 and a second sandwich member 74, as is typical of an ordinary split bushing, for example. A retainer section of shaft 38, such as narrowed section 52, can reside within an opening formed by adjacent indentations 81, 83 of first and second sandwich members 72, 74, respectively. More specifically, again referring to FIG. 6, narrowed section 52 can have a narrower diameter “d” than other adjacent portions of shaft 38 (e.g., having a “D” diameter). Narrowed section 52 can be created by machining, milling or otherwise reducing the diameter of shaft 38 along a portion of the longitudinal length of shaft 38 (e.g., a longitudinal length substantially equal in length or shorter than the portion of shaft 38 passing through second shaft support 70 and/or second bracket 58). In another embodiment, narrowed section 52 can be molded or cast during formation of shaft 38. The opening defined by indentations 81 and 83 can have a diameter large enough to receive narrowed section 52, but small enough to exclude adjacent portions of shaft 38. By associating a narrowed shaft section with a bracket in this manner, the position of shaft 38 can be maintained such that gears 46 and 48 remain consistently operatively meshed with pedal gear 30 and wheel gear 32, respectively.

Although some of FIGS. 1-6 depict a drive system 40 involving a plurality of retainer sections (e.g., enlarged section 50 and narrowed section 52), it is to be understood that a single retainer section in proper association with a bracket can sufficiently prevent longitudinal movement of shaft 38. Accordingly, an exemplary drive system might include a shaft having only a single retainer section that is properly supported and retained by an associated bracket, as for example described above. It should also be understood that an exemplary drive system involving a plurality of retainer sections could include a plurality of narrowed sections but no enlarged sections. Conversely, such a drive system might alternatively comprise a plurality of enlarged sections but no narrowed sections.

Second shaft support 70 can be secured within the cavity of body 78 with a cover 82, for example. Cover 82 can be swiveled with respect to body 78 along a hinge 86, whereby gaps 87 can enable such free swinging of cover 82. Cover 82 can be further held in place against body 78 by one or more fasteners (e.g., bolt 90) inserted through one or more apertures (e.g., 94) in cover 82 and into one or more threaded apertures (e.g., 98) in body 78. Again, it is to be understood that virtually any combination of fasteners, hinges, or other mechanical implements can be employed to secure cover 82 against body 78. It is also to be understood that other mechanical systems (e.g., other than a cover) might be provided to secure second shaft support 70 against body 78.

As further depicted in FIGS. 3 and 4, brackets 56 and 58 can include mating surfaces 69 and 79, respectively, configured to interface a portion of frame 11, such as right wheel support tube 23. These interfaces can involve welding, adhesives, mechanical connection (e.g., screws, bolts, pins), or other fasteners or connectors. Alternatively, mating surface 69 might be configured to associate with a portion of frame 11 different than right wheel support tube 23, such as for example seat post tube 18 and/or bottom bracket housing 34. Likewise, mating surface 79 could alternatively associate with right flange 36 and/or right seat stay tube 24, for example. It is to be understood that brackets 56 and 58 can assume any of a substantial variety of configurations, provided that such brackets can maintain shaft 38 such that the associated gears 46 and 48 can properly drivingly contact pedal gear 30 and wheel gear 32, respectively. Also, in some embodiments, brackets 56, 58 might be provided with grease fittings to enable lubrication of the interfaces between shaft 38 and shaft supports 60, 70, respectively.

A conventional bicycle frame might require certain structural modifications to facilitate association of a direct drive system 40 in accordance with the present invention. For example, as shown in FIG. 1, a cutout 33 might be provided in right flange 36 to ensure proper clearance of second gear 48 as second gear 48 interacts with wheel gear 32. As an alternative to cutout 33, right flange 36 might include a convex, shaped or protruded portion (not shown) that is configured to circumvent second gear 48.

First gear 46 and/or second gear 48 might provide a shroud-type effect for brackets 56 and 58, respectively, particularly when gears 46, 48 are disposed closely to brackets 56 and 58. Also, certain other protective housings or shrouds (not shown) might be associated with frame 11, such as to at least partially enclose wheel gear 32, pedal gear 30, first gear 46, second gear 48, and/or brackets 56, 58. Such housings or shrouds might be implemented in order to further shield certain gearing and/or other moving mechanical parts from dirt, damage or other contact by an operator or by other foreign objects. In one exemplary embodiment, such protective housings might be provided to substantially enclose at least a portion of each of the respective gear interactions (e.g., that present between first gear 46 and pedal gear 30), such as to repel dirt and/or to retain lubrication. In another embodiment, such a shroud or housing might extend along part or all of shaft 38, such as to at least partially prevent contact with shaft 38 by an operator and/or by foreign objects (e.g., dirt).

A bicycle 10 having a drive system 40 can be propelled forward by an operator through forward rotation of the pedals. In one embodiment, a slip-type clutch (e.g., like a ratcheting assembly) can be associated with hub 54 in order that bicycle could coast (e.g., down a hill) without rotating the pedals. Reverse operation might also be enabled, such as during rotation of the pedals in a reverse direction by an operator. However, in alternate embodiments, one or more mechanical components (e.g., a unidirectional clutch) located in bottom bracket housing 34 or in hub 54 might be optionally configured to prevent rearward pedaling by an operator and/or to prevent such rearward pedaling from causing rear wheel 12 to be rotated in a reverse direction. In another embodiment, one or more mechanical components in bottom bracket housing 34 and/or hub 54 might cause braking of bicycle 10 upon an operator's attempted reverse rotation of pedals. It should therefore be understood that pedaling can achieve similar performance from bicycle 10 as would be expected from pedaling a conventional bicycle in a similar manner.

A direct drive system in accordance with the present invention can be easily maintained and serviced by an operator. For example, the shaft can be easily replaced by simply removing the shaft and the shaft supports from within the brackets. Also, the gears can be easily replaced by either replacing the entire shaft or, in some embodiments, by removing and replacing one or more gears from the shaft. In this manner, different shafts, gears, shaft supports and/or other components of the drive system can be implemented depending upon the intended use (e.g., expected racing conditions on a particular day) for the specific bicycle. Also, gears and/or shafts (having integral gears) can be substituted or interchanged in order that an operator can attain different gear ratios between the pedals and the rear wheel (although in some circumstances, it might also be desirable to replace the pedal gear and the wheel gear, particularly to attain drastic alterations in gear ratio). Such a modular system is also easily maintained, as virtually all parts remain readily available for lubrication (e.g., with white lithium grease) and worn parts (e.g., shaft supports) are easily replaceable. In some embodiments, such a system might not even require lubrication, such as when a replaceable wear/lubrication bushing is provided as part of one or more of the brackets. In other embodiments, certain long-lasting plastic components that never require lubrication can be implemented for the shaft, shaft supports, and/or gears. In any event, a drive system in accordance with the present invention can involve fewer components and less complexity than would a typical conventional chain-drive system. Hence, such a direct drive system can also be less expensive and lighter in weight than a conventional chain-drive system. Also, a direct drive system in accordance with the present invention can enable the rear wheel to be more easily replaced than would be possible in a bicycle having a conventional chain-drive system.

The foregoing description of exemplary embodiments and examples of the invention has been presented for purposes of illustration and description. These examples and descriptions are not intended to be exhaustive or limit the invention to the forms described. Numerous modifications are possible in light of the above teachings. Some of those modifications have been discussed, and others will be understood by those skilled in the art. It is hereby intended that the scope of the invention be defined by the claims appended hereto.

What is claimed is:

1. A modular drive system for a bicycle, wherein the bicycle includes a wheel support tube, a pedal crank and a rear wheel, the pedal crank coupled to a pedal gear for rotation therewith, and the rear wheel coupled to a wheel gear for rotation therewith, the drive system comprising:
a shaft having first and second ends spaced at predetermined positions along a single longitudinal axis, the shaft substantially parallel to and spaced from the wheel support tube and having a first gear attached adjacent to the first end and a second gear attached adjacent to the second end, the shaft also having at least one retainer section, wherein said retainer section comprises a diameter different than other adjacent sections of the shaft;
a first bracket adjacent to the pedal gear and carrying a first shaft support comprising an opening sized to rotatably receive a first portion of the shaft;
a second bracket adjacent to the wheel gear and carrying a second shaft support comprising an opening sized to rotatably receive a second portion of the shaft;
wherein said retainer section is associated with one of said first and second portions; and
wherein the first and second shaft supports secure the shaft such that the first gear drivingly contacts the pedal gear and the second gear drivingly contacts the wheel gear.

2. The modular drive system of claim 1 wherein said retainer section comprises a narrowed section of the shaft.

3. The modular drive system of claim 1 wherein said retainer section comprises an enlarged section of the shaft.

4. The modular drive system of claim 1 wherein retainer sections are associated with both of said first and second portions.

5. The modular drive system of claim 1 wherein at least one of the first and second brackets attaches to the wheel support tube.

6. The modular drive system of claim 1 wherein the shaft comprises a continuous shaft.

7. The modular drive system of claim 1 wherein the shaft comprises a one-piece shaft.

8. The modular drive system of claim 1 wherein the first gear and the second gear each have a rotational axis which is coaxial with the longitudinal axis.

9. The modular drive system of claim 1 wherein the first and second shaft supports are spaced inwardly from the first and second ends along the longitudinal axis.

10. The modular drive system of claim 1 wherein at least one of the first and second shaft supports comprises a split bushing.

11. The modular drive system of claim 1 wherein at least one of the first and second shaft supports comprises a cover configured to at least partially enclose a supported retainer section.

12. The modular drive system of claim 11 further comprising a hinge connecting the cover and the at least one of the first and second shaft supports.

13. The modular drive system of claim 11 further comprising at least one fastener connecting the cover in a secured position relative to a supported retainer section.

14. The modular drive system of claim 1, wherein at least one of the first gear and second gear is removably attached to the shaft.

15. The modular drive system of claim 14, further comprising an interlocking key system selectively and non-rotatably connecting the at least one removable gear to the shaft.

16. The modular drive system of claim 14, wherein both of the first and second gears are removably attached to the shaft.

17. A modular drive system for a bicycle, wherein the bicycle includes a wheel support tube, a pedal crank and a rear wheel, the pedal crank coupled to a pedal gear for rotation therewith, and the rear wheel coupled to a wheel gear for rotation therewith, the drive system comprising:
a one-piece continuous shaft having first and second ends spaced at predetermined positions along a single longitudinal axis, the shaft substantially parallel to and spaced from the wheel support tube and having a first gear attached adjacent to the first end and a second gear attached adjacent to the second end, wherein at least one of the first gear and second gear is removably attached to the shaft, the shaft also having at least one retainer section, wherein said retainer section comprises a diameter different than other adjacent sections of the shaft;
a first bracket adjacent to the pedal gear and carrying a first shaft support comprising an opening sized to rotatably receive a first portion of the shaft;
a second bracket adjacent to the wheel gear and carrying a second shaft support comprising an opening sized to rotatably receive a second portion of the shaft;
wherein said retainer section is associated with one of said first and second portions; and
wherein the first and second shaft supports secure the shaft such that the first gear drivingly contacts the pedal gear and the second gear drivingly contacts the wheel gear.

18. The modular drive system of claim 17 wherein the first gear and the second gear each have a rotational axis which is coaxial with the longitudinal axis.

19. The modular drive system of claim 17, further comprising an interlocking key system selectively and non-rotatably connecting the at least one removable gear to the shaft.

20. The modular drive system of claim 17, wherein both of the first and second gears are removably attached to the shaft.
